(19) United States
(12) Patent Application Publication
(10) Pub. No.: US 2017/0325169 A1
(43) Pub. Date: Nov. 9, 2017

(54) POWER FALLBACK WIRELESS LOCAL AREA NETWORK RECEIVER

(71) Applicant: QUALCOMM Incorporated, San Diego, CA (US)

(72) Inventors: Mohammad EMADI, San Jose, CA (US); Alireza KHALILI, Sunnyvale, CA (US); Mazhareddin TAGHIVAND, Campbell, CA (US); Youhan KIM, San Jose, CA (US); Kai DIETZE, San Francisco, CA (US); Michael KOHLMANN, San Francisco, CA (US); James GARDNER, San Ramon, CA (US); Tevfik YUCEK, San Jose, CA (US); Beomsup KIM, Los Altos Hills, CA (US)

(21) Appl. No.: 15/448,152

(22) Filed: Mar. 2, 2017

Related U.S. Application Data
(60) Provisional application No. 62/333,118, filed on May 6, 2016.

(51) Int. Cl. H04W 52/02; H04B 17/318; H04W 84/12

(52) U.S. Cl. CPC H04W 52/0245; H04B 17/318; H04W 84/12

(57) ABSTRACT

Power conservation in a radio frequency front end of a user equipment (UE) during wireless local area network (WLAN) communication is achieved by adjusting a power mode of the radio frequency front end. In one instance, the UE determines a signal strength of a received frame of a packet during a short training field of a preamble of the received frame. The determining occurs when a WLAN receiver is operating in a low power mode. The UE then switches the WLAN receiver to a high power mode during the short training field of the preamble or during a first segment of a long training field of the preamble when the signal strength is above a predetermined signal strength.

### CROSS-REFERENCE TO RELATED APPLICATION

The present application claims the benefit of U.S. Provisional Patent Application No. 62/333,118, filed on May 6, 2016, and titled “AUTOMATIC POWER FALLBACK WIRELESS LOCAL AREA NETWORK,” the disclosure of which is expressly incorporated by reference herein in its entirety.

### TECHNICAL FIELD

Aspects of the present disclosure relate generally to communication systems, and specifically to power conservation in a radio frequency front end of a user equipment (UE) during wireless local area network (WLAN) communication.

### BACKGROUND

Many wireless devices are capable of wireless communication with other devices using wireless local area network (WLAN) signals, Bluetooth (BT) signals, and/or cellular signals. For example, many laptops, netbook computers, and tablet devices use WLAN signals (for example, Wi-Fi signals) to wirelessly connect to networks such as the Internet and/or private networks, and use Bluetooth signals to communicate with local BT-enabled devices such as headsets, printers, scanners, and the like. Wi-Fi communications are governed by the IEEE 802.11 family of standards, and Bluetooth communications are governed by the IEEE 802.15 family of standards. Wi-Fi and Bluetooth signals typically operate in the ISM band (e.g., 2.4-2.48 GHz). Further, modern mobile communication devices (such as tablet devices and cellular phones) are also capable of wireless communication using cellular protocols such as long term evolution (LTE) protocols, which may operate in the range of 2.5 GHz.

As the demand for mobile broadband access continues to increase, research and development continue to advance to meet the growing demand for mobile broadband access, and to enhance the user experience with mobile communications.

### SUMMARY

According to one aspect of the present disclosure, a method of wireless communication includes determining a signal strength of a received frame of a packet during a short training field of a preamble of the received frame. The determining occurs when a WLAN receiver is operating in a low power mode. The method also includes switching the WLAN receiver to a high power mode during the short training field of the preamble or during a first segment of a long training field of the preamble when the signal strength is above a predetermined signal strength.

According to another aspect of the present disclosure, an apparatus for wireless communication includes means for determining a signal strength of a received frame of a packet during a short training field of a preamble of the received frame. The means for determining operates when a WLAN receiver is operating in a low power mode. The apparatus may also include means for switching the WLAN receiver to a high power mode during the short training field of the preamble or during a first segment of a long training field of the preamble when the signal strength is above a predetermined signal strength.

Another aspect discloses an apparatus for wireless communication for a UE (user equipment) and includes a memory and at least one processor coupled to the memory. The processor(s) is configured to determine a signal strength of a received frame of a packet during a short training field of a preamble of the received frame. The determining occurs when a WLAN receiver is operating in a low power mode. The processor(s) is also configured to switch the WLAN receiver to a high power mode during the short training field of the preamble or during a first segment of a long training field of the preamble when the signal strength is above a predetermined signal strength.

Yet another aspect discloses a non-transitory computer-readable medium having program code recorded thereon for use by a UE (user equipment) for wireless communication. When executed by a processor(s), the program code causes the processor(s) to determine a signal strength of a received frame of a packet during a short training field of a preamble of the received frame. The determining occurs when a WLAN receiver is operating in a low power mode. The program code further causes the processor(s) to switch the WLAN receiver to a high power mode during the short training field of the preamble or during a first segment of a long training field of the preamble when the signal strength is above a predetermined signal strength.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is an example of a wireless communication system.

FIG. 2 is a block diagram of an aspect of a wireless communications transceiver unit that comprises a WLAN module, and a Bluetooth module.

FIG. 3 shows a block diagram of a wireless communication device.

FIG. 4 illustrates a power saving implementation on communication frames (e.g., WLAN frames) received by a power fallback local area network receiver according to aspects of the present disclosure.

FIG. 5 illustrates another power saving implementation on communication frames received by a power fallback local area network receiver according to aspects of the present disclosure

FIG. 6 illustrates a communication framework of an access point (AP) and a station (e.g., a user equipment) according to aspects of the present disclosure.

FIGS. 7A and 7B illustrate state diagrams of power consumption modes of the WLAN receiver according to aspects of the present disclosure.

FIG. 8 is a flow chart depicting another exemplary operation of a wireless device in accordance with some aspects.

FIG. 9 is a diagram illustrating an example of a hardware implementation for an apparatus employing a power saving WLAN receiver.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR,” and the use of the term “or” is intended to represent an “exclusive OR.”

A radio frequency front end (RFFE) includes a receiver, transmitter and/or transceiver that operates in accordance with multiple power consumption modes. The receiver, transmitter and/or transceiver may be in various power consumption modes including a standby mode or an active mode with respect to radio access technology communications such as wireless local area network (WLAN) communications. For example, a WLAN card/module and/or a WLAN receiver/transmitter associated with the WLAN card/module may be in the active mode. While in the active mode, the WLAN receiver may receive data from a WLAN access point or a WLAN transmitter may transmit data to the WLAN access point. To reduce the WLAN-related power consumption, many conventional WLAN cards and/or WLAN receivers/transmitters can be operated in a standby mode when no exchange of data packets between a host computer system (e.g., user equipment) and an access point is specified. Although aspects of the disclosure are described with respect to WLAN communications, the aspects are equally applicable to other radio access technologies. For illustrative purposes, the disclosure is directed to receivers (e.g., WLAN receivers). The disclosure, however, may be equally applicable to transmitters or transceivers.

Aspects of the present disclosure are directed to power conservation in a radio frequency front end of a user equipment (UE) during wireless local area network (WLAN) communication. Power consumption during the WLAN communication may be reduced by introducing a power saving mode to adjust power allocated to a WLAN receiver. For example, a WLAN receiver may be switched to a high power mode from a low power mode during a preamble or header of a received frame (based on WLAN protocol) of a packet. The WLAN receiver operating in accordance with this power saving mode may be referred to as a power fallback local area network receiver or auto power fallback (APF) receiver. The switching may occur when a signal strength (e.g., received signal strength indication (RSSI)) of the received frame is above a predetermined signal strength. The determination of the signal strength of the received frame occurs during the preamble of the frame when the WLAN receiver is operating in the low power mode.

For example, if the RSSI becomes less than a predetermined threshold value, a low power mode is maintained and there is no need to switch to high power mode to support RSSIs above the predetermined threshold. Because in the low power mode the noise factor (NF) is dominant, all other impairments that will not change the NF are relaxed. For example, tolerance of impairments such as inter carrier interference (ICI), non-linearity, ADC effective number of bit or any source of the impairment that will not change the noise factor are relaxed. Aspects of the present disclosure are also directed to other cases where the number of spatial streams or modulating and coding scheme (MCS) is less than some specific number. For example, switching the WLAN receiver from the high power mode to the low power mode is based on a modulating and coding scheme index (MCS), a spatial stream, a WLAN standard, and/or a quality of service. The WLAN standards include 802.11b, 802.11g, 802.11a, 802.11n, 802.11ac, 802.11ad, 802.11ah, 802.11ax, etc.

In the standby mode, the WLAN receiver/transmitter is inactive or subject to a period of limited activity. Conventionally, the standby mode of the WLAN receiver/transmitter is limited to two modes, a sleep mode and a listening mode. For example, the operation of the WLAN receiver/transmitter in the sleep mode causes a communication link between the WLAN receiver of the UE and a WLAN access point to be temporarily disabled. In this mode, a majority of the WLAN card circuitry is turned off, except for certain critical parts. In the sleep mode, the receiver wakes up periodically. In the listening mode, the WLAN receiver is always on and waiting to receive data. For example, in the listen mode the receiver is always on to receive traffic from the access point including listening for beacon signals announcing the presence and readiness of the access point. However, no data packets are exchanged between the access point and the UE in the listening mode and the sleep mode.

Increasingly, the WLAN receiver is in power consumption mode, including the sleep mode or the listen mode. The WLAN receiver, however, may also be in a power consumption mode where signals that are not allocated for WLAN communications with the UE are received by the WLAN receiver. For example, signals for other UEs in the vicinity of a host UE may be decoded by the host UE. This power consumption mode may be referred to as receive (other) mode, which is different from a full receive mode to receive signals intended for the host UE.

Some WLAN receivers use a same power level for all of the power consumption modes except for the sleep mode. For example, the same power level is used whether the WLAN receiver is in the listen (search) mode, the receive (other) mode or in the full receive mode. Using the same power level for all of these power consumption modes is power inefficient. For example, operating the WLAN receiver in accordance with a high power mode (relative to a low power mode for sleep mode) for all of these power consumption modes is inefficient.

Aspects of the present disclosure are directed to a new receive mode known as auto power fallback receive (APF-RX) mode to support listening for a frame and reception of a frame. In one aspect of the disclosure, a radio frequency module (e.g., wireless controller, or WLAN card) determines a signal strength (e.g., received signal strength indicator (RSSI)) of a received frame of a packet during a preamble of the frame. This determination is made when the WLAN receiver is operating in a low power mode. The radio frequency module may then switch the WLAN receiver to a high power mode during the preamble of the frame when the signal strength is above a predetermined signal strength. For example, the predetermined signal strength is −55 dBm, −60 dBm, −65 dBm or another desirable value. In some implementations, a power consumption mode of the WLAN receiver may be based on a bias current of the WLAN receiver. The low power mode may be associated with a low bias current while the high power mode is associated with a high bias current. For example, a low bias current may be 5 mA from a 1.2 V supply voltage while a high bias current may be about 30 mA. The aspects of the present disclosure may be implemented in a system, such as the system illustrated in FIG. 1.

Referring first to FIG. 1, a block diagram illustrates an example of a WLAN network 100 such as, e.g., a network implementing at least one of the IEEE 802.11 family of standards. The WLAN network 100 may include an access point (AP) 105 and one or more wireless devices 110 or stations (STAs), such as mobile stations, user equipment, personal digital assistants (PDAs), other handheld devices, netbooks, notebook computers, tablet computers, laptops, display devices (e.g., TVs, computer monitors, etc.), printers, and the like. While only one AP 105 is illustrated, the WLAN network 100 may have multiple APs 105. Each of the wireless devices 110, which may also be referred to as mobile stations (MSs), mobile devices, access terminals (ATs), user equipment (UE), subscriber stations (SSs), or subscriber units, may associate and communicate with an AP 105 via a communication link 115. Each AP 105 has a geographic coverage area 125 such that wireless devices 110 within that area can communicate with the AP 105. The wireless devices 110 may be dispersed throughout the geographic coverage area 125. Each wireless device 110 may be stationary or mobile.

A wireless device 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) is used to connect APs 105 in an extended service set. A geographic coverage area 125 for an access point 105 may be divided into sectors making up only a portion of the coverage area. The WLAN network 100 may include access points 105 of different types (e.g., metropolitan area, home network, etc.), with varying sizes of coverage areas and overlapping coverage areas for different technologies. In other examples, other wireless devices can communicate with the AP 105.

While the wireless devices 110 may communicate with each other through the AP 105 using communication links 115, each wireless device 110 may also communicate directly with one or more other wireless devices 110 via a direct wireless link 120. Two or more wireless devices 110 may communicate via a direct wireless link 120 when both wireless devices 110 are in the AP geographic coverage area 125 or when one or neither wireless device 110 is within the AP geographic coverage area 125. Examples of direct wireless links 120 may include Wi-Fi Direct connections, connections established by using a Wi-Fi Tunneled Direct Link Setup (TDLS) link, and other P2P group connections. The wireless devices 110 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, and the like. In other implementations, other peer-to-peer connections and/or ad hoc networks may be implemented within WLAN network 100.

The AP 105 may include an AP frequency agile radio 140. A frequency agile radio is a transceiver that can dynamically change bandwidth modes. The bandwidth modes may utilize different frequency channels, and may include an 80 MHz mode, an 80+80 MHz mode, a 160 MHz contiguous mode, and a 165 MHz mode. In other examples, other bandwidth modes may be used. The AP 105 may communicate with the wireless devices 110 or other APs over different bandwidths using the AP frequency agile radio 140.

At least one of the wireless devices 110 may also include a station frequency agile radio 145. The STA frequency agile radio 145 can also dynamically change bandwidth modes to communicate with another wireless device 110 or the AP 105 over a selected bandwidth mode. The selected bandwidth mode may be, for example, the 80 MHz mode, the 80+80 MHz mode, the 160 MHz mode, and the 165 MHz mode. In other examples, the STA frequency agile radio 145 may use other bandwidth modes.

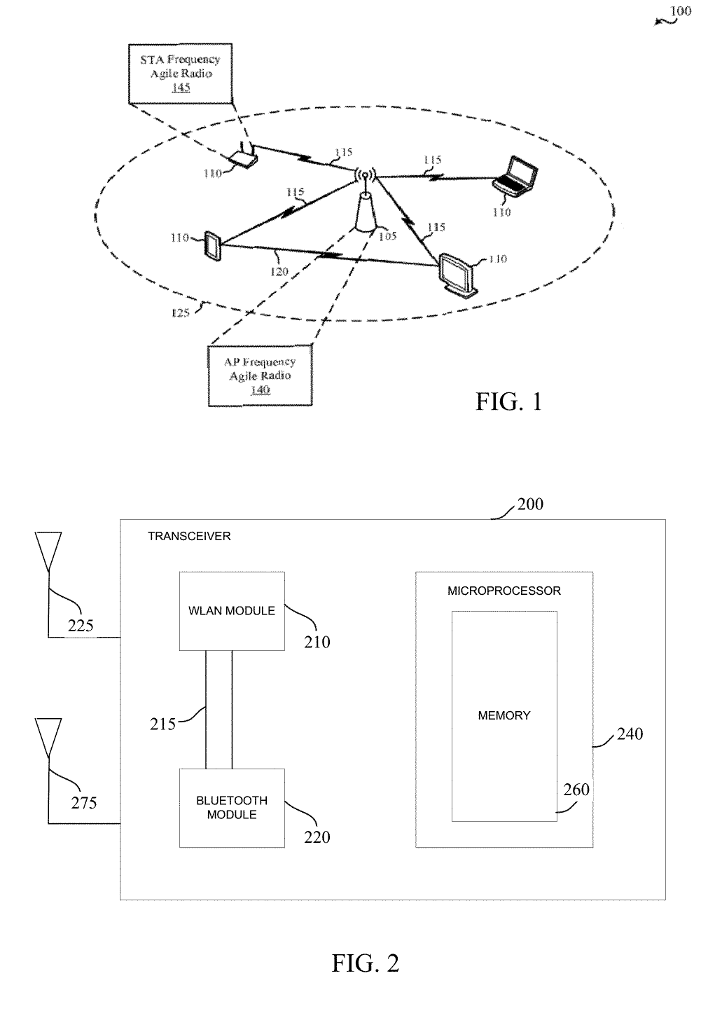

FIG. 2 illustrates a diagram of a portion of a wireless communications unit 200 within a user equipment (UE) that includes a WLAN module 210 and a Bluetooth module 220 in accordance with aspects of the present disclosure. The various circuit components that comprise the WLAN circuitry in the wireless communication unit 200 are generally designated as the WLAN module 210. Similarly, the various circuit components that comprise the Bluetooth circuitry in the wireless communication unit 200 are generally designated as the Bluetooth module 220. The Bluetooth module 220 is coupled to the WLAN module 210 and is capable of communicating state information to the WLAN module 210 through signal lines 215.

The UE or the transceiver unit 230 includes a microprocessor 240. The microprocessor 240 comprises a memory 260. The microprocessor 240 receives information from the WLAN module 210 and from the Bluetooth module 220 via signal lines that are not shown in FIG. 2. The microprocessor 240 sends control signals to the WLAN module 210 and to the Bluetooth module 220 via control signal lines that are also not shown in FIG. 2.

The microprocessor 240 carries out the methods of the present disclosure along with the WLAN module 210. The wireless communications unit 200 may concurrently run two access technologies (Bluetooth and WLAN) for two different applications. A computer program product including a computer-readable medium that includes code for carrying out computer instructions to perform the method may be included or associated with the UE.

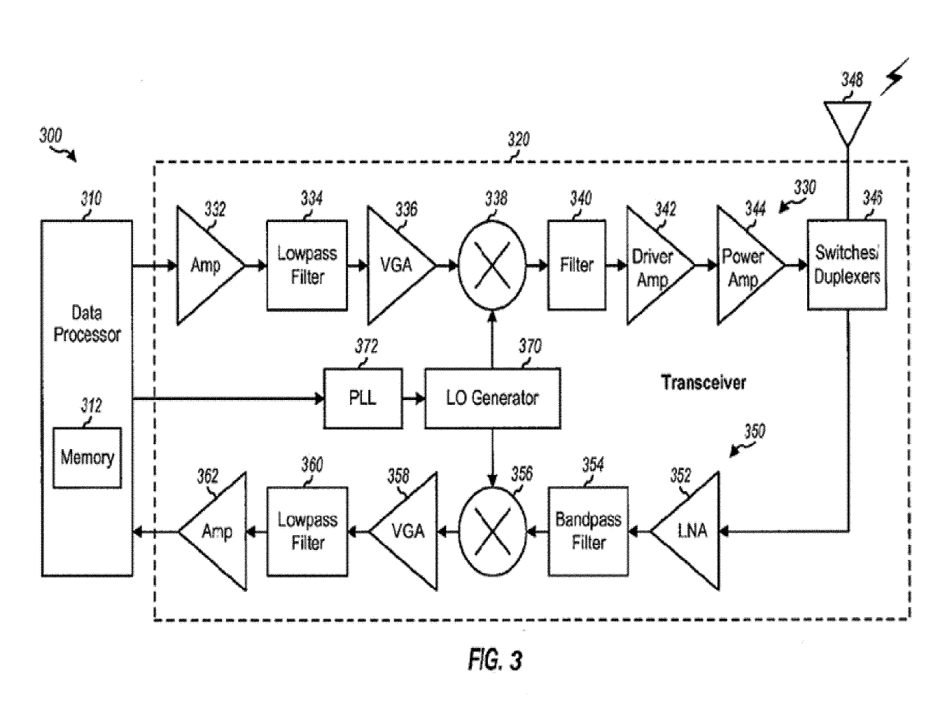

FIG. 3 shows a block diagram of an exemplary design of a wireless communication device 300. In this exemplary design, the wireless device 300 includes a data processor 310 and a transceiver 320. The transceiver 320 includes a transmitter 330 (e.g., WLAN transmitter) and a receiver 350 (e.g., WLAN receiver) that support bi-directional wireless communication. In general, the wireless device 300 may include any number of transmitters and any number of receivers for any number of communication systems and any number of frequency bands.

In the transmit path, the data processor 310 processes data to be transmitted and provides an analog output signal to the transmitter 330. Within the transmitter 330, the analog output signal is amplified by an amplifier (Amp) 332, filtered by a low pass filter 334 to remove images caused by digital-to-analog conversion, amplified by a variable gain amplifier (VGA) 336, and upconverted from baseband to radio frequency (RF) by a mixer 338. The upconverted signal is filtered by a filter 340, further amplified by a driver amplifier 342 and a power amplifier 344, routed through switches/duplexers 346, and transmitted via an antenna 348.

In the receive path, the antenna 348 receives signals from base stations and/or other transmitter stations and provides a received signal, which is routed through the switches/duplexers 346 and provided to the receiver 350. Within the receiver 350, the received signal is amplified by a low noise amplifier (LNA) 352, filtered by a bandpass filter 354, and downconverted from radio frequency to baseband by a mixer 356. The downconverted signal is amplified by a VGA 358, filtered by a low pass filter 360, and amplified by an amplifier 362 to obtain an analog input signal, which is provided to the data processor 310.

FIG. 3 shows the transmitter 330 and the receiver 350 implementing a direct-conversion architecture, which frequency converts a signal between radio frequency and baseband in one stage. The transmitter 330 and/or the receiver 350 may also implement a super-heterodyne architecture, which frequency converts a signal between radio frequency and baseband in multiple stages. A local oscillator (LO) generator 370 generates and provides transmit and receive LO signals to the mixers 338 and 356, respectively. A phase locked loop (PLL) 372 receives control information from the data processor 310 and provides control signals to the LO generator 370 to generate the transmit and receive LO signals at the proper frequencies.

FIG. 3 shows an exemplary transceiver design. In general, the conditioning of the signals in the transmitter 330 and the receiver 350 may be performed by one or more stages of amplifies, filters, mixes, etc. These circuits may be arranged differently from the configuration shown in FIG. 3. Furthermore, other circuits not shown in FIG. 3 may also be used in the transmitter and the receiver. For example, matching circuits may be used to match various active circuits in FIG. 3. Some circuits in FIG. 3 may also be omitted. The transceiver 320 may be implemented on one or more analog integrated circuits (ICs), radio frequency ICs (RFICs), mixed-signal ICs, etc. For example, the amplifier 332 through the power amplifier 344 in the transmitter 330 may be implemented on an RFIC. The driver amplifier 342 and the power amplifier 344 may also be implemented on another IC external to the RFIC.

The data processor 310 may perform various functions for the wireless device 300, e.g., processing for transmitted and received data. A memory 312 may store program codes and data for the data processor 310. The data processor 310 may be implemented on one or more application specific integrated circuits (ASICs) and/or other ICs.

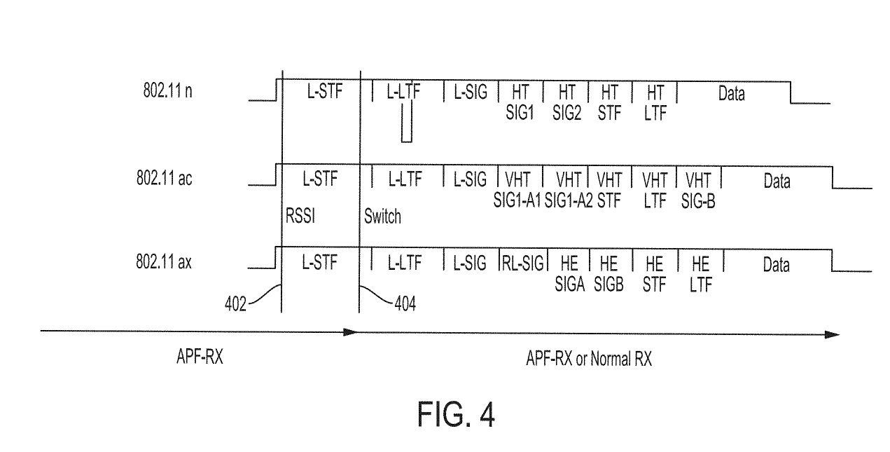

FIG. 4 illustrates a power saving implementation on communication frames (e.g., WLAN frames) according to aspects of the present disclosure. A communication frame for WLAN communications may be transmitted in accordance with multiple formats. For example, a WLAN frame may include a preamble portion and a data portion. The preamble portion of the WLAN frame may include a legacy short training field (L-STF) portion and a legacy long training field (L-LTF), as illustrated in FIG. 4. The L-STF, along with L-LTF, contain information that allows the device to detect the signal, perform frequency offset estimation, timing synchronization, etc.

In a legacy mode one or more communication frames are transmitted in different formats. For example, the frame can be transmitted in accordance with 802.11n format, 802.11ac format or 802.11ax format. Thus, packets or data may be transmitted with a preamble compatible with the legacy 802.11a/ac/ax. Legacy short training sequence, legacy long training sequence, and the legacy signal description are transmitted so they can be decoded by legacy 802.11a/ac/ax devices. The legacy short training sequence of the 802.11n standard includes the L-STF, and high throughput short training field (HT-STF). The legacy long training sequence of the 802.11n standard includes the L-LTF, and high throughput long training field (HT-LTF). The other legacy signal description of the 802.11n standard include a legacy signal field (L-SIG), a high throughput signal field1 (HT-SIG1), and a high throughput signal field2 (HT-SIG2).

The legacy short training sequence of the 802.11ac standard includes the L-STF, and very high throughput short training field (VHT-STF). The legacy long training sequence of the 802.11ac standard includes the L-LTF, and a very high throughput long training field (VHT-LTF). The other legacy signal description of the 802.11ac standard includes the L-SIG, a very high throughput signal field1-A1 (VHT-SIG1-A1), a very high throughput signal field1-A2 (VHT-SIG1-A2), and a very high throughput signal field-B (VHT-SIG-B).

The legacy short training sequence of the 802.11ax standard includes the L-STF and a high efficiency short training field (HE-STF). The legacy long training sequence of the 802.11ax standard includes the L-LTF, and a high efficiency long training field (HE-LTF). The other legacy signal description of the 802.11ax standard includes the legacy signal field (L-SIG), a repeated legacy signal field (RL-SIG), a high efficiency signal field-A (HE-SIGA), and a high efficiency signal field-B (HE-SIGB).

In one aspect of the disclosure, the radio frequency module determines the signal strength of the received frame of the packet during the L-STF portion of the preamble. For example, the signal strength of the received frame is determined at a time during the preamble of the different frame formats indicated by the line 402 of FIG. 4. In this aspect, the radio frequency module causes the WLAN receiver to switch to the higher power mode during the L-STF portion of the preamble. For example, the switching occurs at a time during the preamble of the different formats indicated by the line 404 of FIG. 4. The switching occurs after the determination of the signal strength of the frame. The switching occurs when a signal strength of the received frame is above a predetermined signal strength or threshold. In one aspect of the disclosure, determining a power measurement for the different power modes may be achieved by a digital and/or analog implementation.

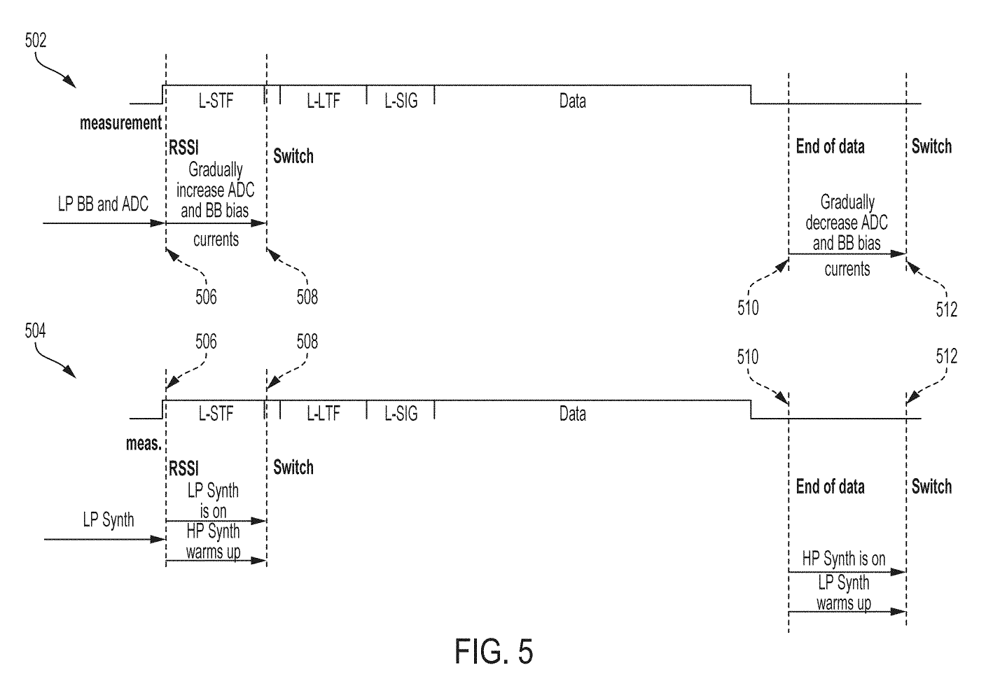

FIG. 5 illustrates a power saving implementation on communication frames (502 and 504) according to aspects of the present disclosure. The communication frames 502 and 504 may be similar to the communication frames described with respect to FIG. 4. For example, each of the communication frames 502 and 504 includes a preamble portion and a data portion. The preamble portion includes L-STF, L-LTF and L-SIG. In this example, the radio frequency module determines the signal strength of the received frame of the packet during the L-STF portion of the preamble and causes the WLAN receiver to switch to the higher power mode either during a first segment of the L-LTF portion of the preamble or during an end of the L-STF portion of the preamble. In one aspect, a time for determining whether the signal strength of the frame is above the threshold may be one micro second (1 μs) from the start of the preamble portion. For example, a first segment may be up to 1 micro second from the start of the L-LTF portion. A last segment may be up to 2 micro second from the start of the L-STF portion. For example, the signal strength of the received frame is determined at a time during the L-STF preamble portion of the communication frames 502 and 504 indicated by the line 506. The switching occurs at a time during the L-LTF preamble portion of the communication frames 502 and 504 indicated by the line 508.

Aspects of the disclosure avoid switching toward the end portion of the preamble. Switching at an end or middle of the preamble (e.g., at an end or middle of the L-LTF portion of the preamble) may cause loss of data. For example, channel estimation or other synchronization functions may occur at the end of the L-LTF portion. These functions may cause a phase of a local oscillator to change, which subsequently causes a loss of data.

In a further aspect of the disclosure, the radio frequency module switches the WLAN receiver from the high power mode to the low power mode when it is determined that an end of data for the packet is reached (at a time corresponding to line 510). The end of the data may be determined by monitoring data signals (e.g., by the radio frequency module) to determine whether the data signals fall below a threshold value. For example, an end of data occurs when the data signal falls below a predefined threshold. The WLAN receiver is switched to the lower power mode at a time (corresponding to line 512) after the end of data is determined.

Alternatively, an end of data indication may be provided by a modem. For example, the modem monitors the reception of data and determines when an end of the data occurs. The modem then generates a flag to indicate the end of the data. The flag may be provided to the radio frequency module, which causes the WLAN receiver to enter the low power mode.

Most of the time, a WLAN receiver is between listen and sleep modes. The sleep mode may include a delivery traffic indication map (DTIM). Most of the power consumed during reception of data and during the listening mode is consumed by a synthesizer and local oscillator (LO), analog to digital convertor, as well as baseband (BB) devices. For example, the synthesizer may be a combination of the PLL 372 and the LO generator 370. The baseband devices may include the VGA 336, the low pass filter 334/360 and amplifier 332/342/344. Accordingly, aspects of the present disclosure are directed to a new receive mode known as auto power fallback receive (APF-RX) mode to support listening and receiving, especially during the synthesizer and LO activity as well as the baseband and analog to digital processing. For example, in the power saving mode (prior to the determination of signal strength at the time indicated by the line 506), a low power mode of operation of some of the devices of the radio frequency front end is implemented. For example, the baseband devices, the synthesizer and/or other devices such as an analog to digital converter of the radio frequency front end operate at a very low power.

One way to reduce the power of the baseband devices and/or the other devices, including the analog to digital converter, is through bias control. For example, to save power a bias current to the baseband devices and/or the other devices is reduced. However, when the signal strength of the received frame is above a predetermined signal strength, the bias current to the baseband device and the analog to digital converter is gradually increased. The bias current is increased to bring devices to an operational level for receiving the data from the frame. For example, a time for gradually increasing the bias current to the baseband device and the analog to digital converter or to switch to the high power mode after the signal strength determination may be up to six micro seconds (6 μs). After the data is received (e.g., the end of the data corresponding to line 510), however, the bias current to the baseband device and the analog to digital converter is gradually decreased. The reduced bias current causes power consumed by the baseband device and the analog to digital converter to be reduced. This follows because the switch to the low power mode of operation of the WLAN receiver coincides with the low power mode of operation of the baseband device and the analog to digital converter. In one aspect of the disclosure, a sampling frequency of the ADC may also be reduced. Although bias control is shown as an example of a low power implementation, other solutions are also available. For example, bias control may also be implemented with the synthesizer.

Other solutions for the low power implementation include switching between low power synthesizers when the WLAN receiver is operating in accordance with a low power mode (e.g., sleep mode) to a high power synthesizer in the high power mode (e.g., for receiving data). For example, only the low power synthesizer is on during the low power mode of operation of the WLAN receiver. However, when it is determined that the signal strength of the received frame is above a predetermined signal strength (at time corresponding to line 506), a radio frequency module or controller causes the high power synthesizer to warm up. While the high power synthesizer is warming up, the low power synthesizer is kept on. For example, a time for warming up the high power synthesizer or to switch to the high power mode after the signal strength determination may be up to 6 micro seconds (6 μs). The low power synthesizer may be turned off when the radio frequency module or controller causes the WLAN receiver to switch (at time corresponding to line 508) from the low power mode to the high power mode. After the switch of the WLAN receiver to the high power mode, the high power synthesizer is powered on until the WLAN receiver is switched back (at time corresponding to line 512) to the low power mode supported by the low power synthesizer. The low power synthesizer warms up between the time corresponding to the end of the data (line 510) and the switch of the WLAN receiver to the low power mode (line 512).

Aspects of the present disclosure reduce power consumption during synthesizer operation (e.g., up to eighty percent) and reduce analog baseband power consumption to as low as fifty percent of the analog baseband power consumption in conventional receivers. Further, aspects of the present disclosure reduce power consumption by the analog to digital converter by approximately fifty percent compared to power consumption in current analog to digital converters. Signal to noise and distortion ratio (SNDR) for the analog to digital converter may also be reduced by 5 dB when the signal strength of the frame is less than −50 dBm.

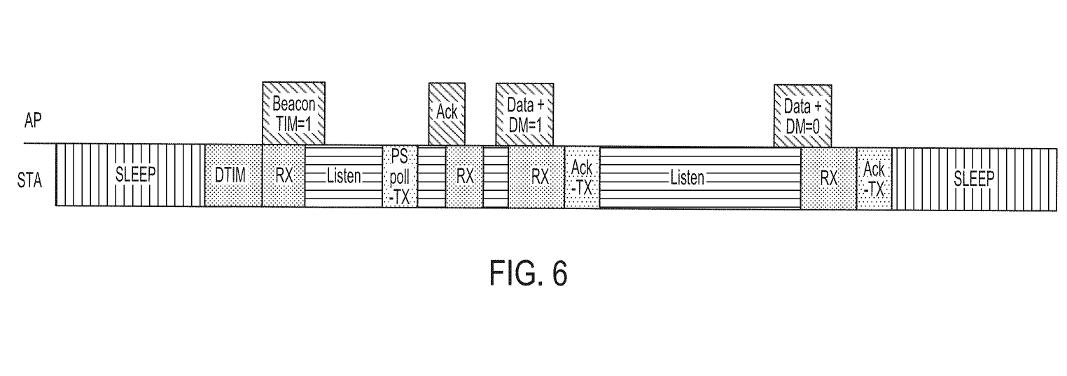

FIG. 6 illustrates a communication framework of an access point (AP) and a station (e.g., a user equipment) according to aspects of the present disclosure. A wireless local area network (WLAN) operating in an infrastructure basic service set (BSS) mode includes the access point for the BSS and one or more stations (STAs) associated with the access point. Traffic to the STAs that originates from outside the BSS arrives through the access point and is delivered to the STAs. Traffic originating from the STAs to destinations outside the BSS is sent to the access point to be delivered to the respective destinations.

A traffic indicator message (TIM)-based power saving implementation may be used in some networks. In this implementation, the access point is aware of the current power saving modes used by STAs it is addressing and buffers the traffic status for STAs that are in a sleep mode. The access point notifies corresponding STAs using the TIM/delivery traffic indication messages (DTIM) in beacon frames (e.g., Beacon TIM=1). The STA, which is addressed by the access point, may achieve power savings by entering into the sleep mode, and waking up to listen for beacons, to receive the TIM, and/or to check if the access point has buffered traffic for it to receive. The STA may send a power saving (PS)-Poll (e.g., PS-poll-TX) control frame to retrieve buffered frames from the AP.

The STA operating in the power saving mode transmits the short PS-Poll-TX frame to the access point. The AP responds with the corresponding data immediately, or acknowledges (Ack) the PS-Poll and responds with the corresponding data at a later time. The STA transmits an acknowledgement (Ack-Tx) after receipt of the data (DM0/DM1) and returns to listen mode or sleep mode.

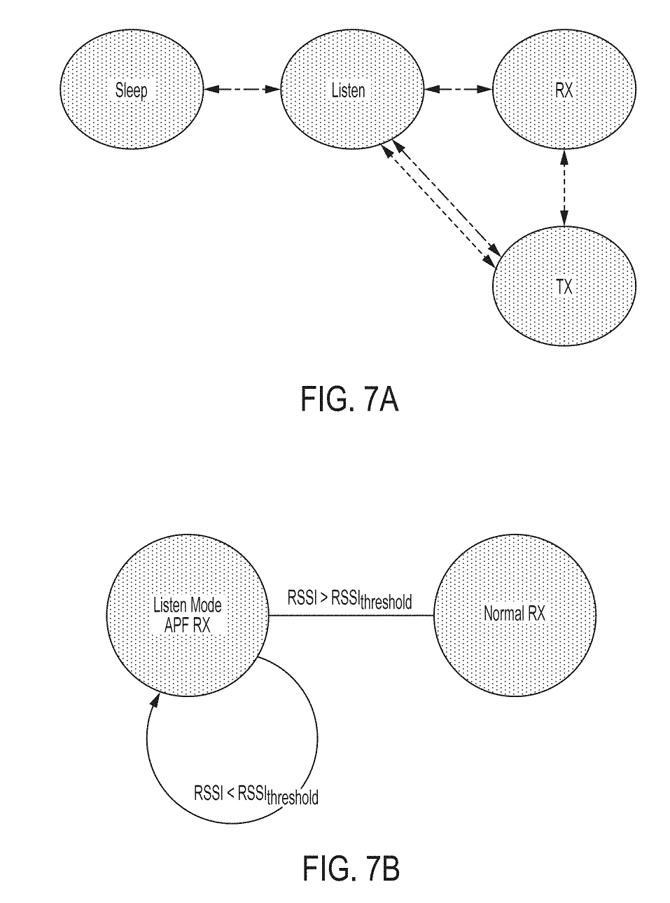

FIGS. 7A and 7B are exemplary state diagrams of power consumption modes of the WLAN receiver according to aspects of the present disclosure. The WLAN receiver transitions (indicated by the arrows of FIGS. 7A and 7B) between multiple power saving modes including a sleep mode, a listening mode, a receive (RX) mode and a transmit (TX) mode. In the sleep mode, the WLAN receiver may be operated in accordance with a low power mode. In the transmit and receive modes, the WLAN receiver may operate in accordance with a high power mode. In the listening mode, the WLAN receiver may operate in accordance with the APF-RX mode using the power fallback wireless local area network receiver or APF-RX receiver. The WLAN receiver stays in the APF-RX mode when the signal strength (e.g., RSSI) of the frame is less than the predetermined signal strength, as illustrated in FIG. 7B. However, when the signal strength of the frame is greater than the predetermined signal strength, the WLAN receiver switches to the normal or full receive mode where the WLAN receiver is operating in accordance with a high power mode, as illustrated in FIG. 7B.

Listening in accordance with the APF-RX mode provides power savings compared to the full receive mode. In some instances, only one antenna and/or receiver of multiple antennas/receivers available to the UE are used during the listening mode when the APF-RX mode is implemented. The other antennas/receivers may be turned on when it is determined that a signal (e.g., data) is being received. In some instances, overall power reduction may be up to seventy percent in power saving mode or APF-RX mode. The overall power reduction associated with the APF-RX mode extends the overall battery life of the user equipment.

In some instances, good inter carrier interference (ICI) may not be specified for APF-RX mode. An example of such an instance includes when a bandwidth (BW) is approximately 80 MHz and the signal strength of the frame is less than −60 dBm. Also, in the presence of jammers and interference the implementation maintains or switches to a high power mode.

Aspects of the present disclosure may be implemented on current radio frequency front end devices with minor changes to achieve desirable noise figure specifications. Although achieving a desirable noise figure is specified for the listen mode, other aspects such as linearity, ICI (inter carrier interference) or low quantization noise may be more relaxed or less desirable. Accordingly, a low noise amplifier (LNA), mixer (e.g., GM mixer), and trans-impedance amplifier (TIA) of the radio frequency front end may be unchanged while baseband stages like a biquad amplifier (BQ), a power gain amplifier (PGA) and the ADC are switched or maintained at the low power mode.

The predetermined signal or threshold divides the dynamic range of the signal strength of the frame into two regions separated by the threshold. Based on the threshold implementation, only a certain error vector magnitude (EVM) or signal strength is specified to reliably receive signals lower than this limit. The APF receiver (operating in accordance with the APF-RX mode) or power fallback wireless local area network receiver is used in this case. Front end noise factor (NF) is dominant (not analog to digital converter/baseband or inter channel interference (ICI)) in this region. Thus, the EVM is relaxed. For larger signals, however, a main receiver operating in accordance with the high power mode, for example, may be used. The EVM specifications for preambles up to the end of the L-STF are also very relaxed due to a low modulation index. Therefore, in the beginning of the packet, the APF mode can be used.

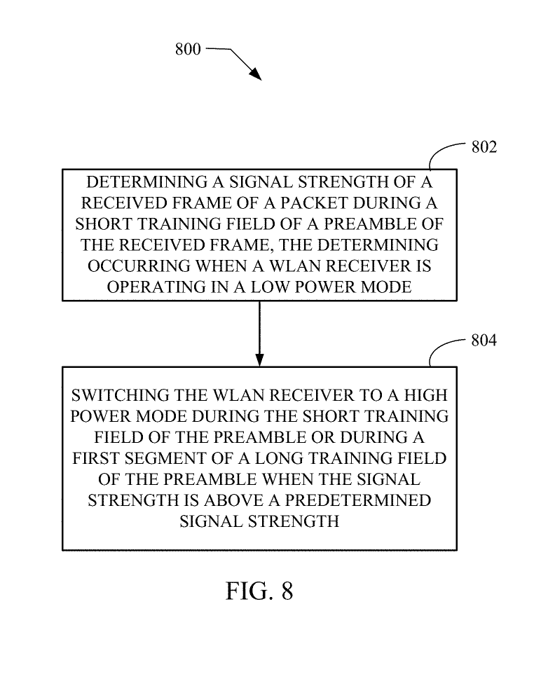

FIG. 8 is a process flow diagram 800 illustrating a wireless local area network (WLAN) communication method according to aspects of the present disclosure. In block 802, a user equipment determines a signal strength of a received frame of a packet during a short training field, such as a legacy short training field (L-STF), of a preamble of the received frame. The determining occurs when a WLAN receiver of the user equipment is operating in a low power mode. In block 804, the user equipment switches the WLAN receiver to a high power mode during the short training field portion of the preamble or during a first segment of a long training field, such as a legacy long training field (L-LTF), of the preamble when the signal strength is above a predetermined signal strength.

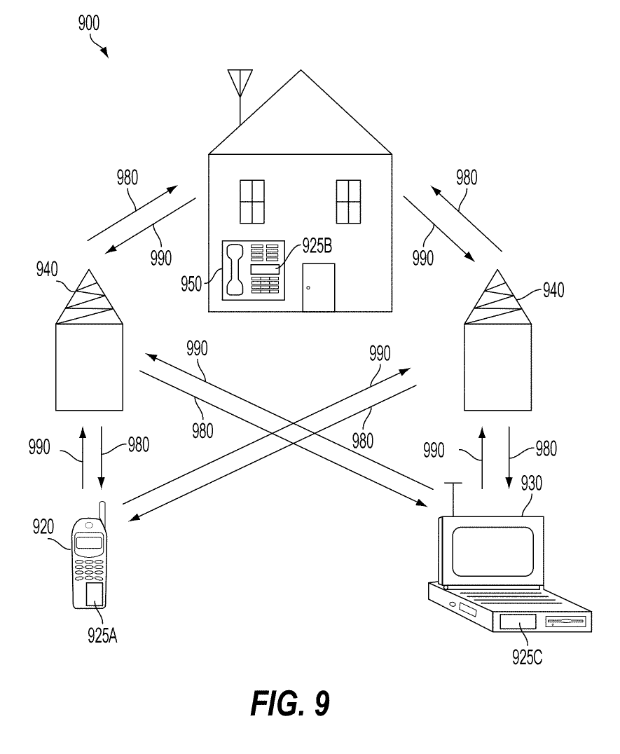

FIG. 9 is a block diagram showing an exemplary wireless communication system 900 in which an aspect of the disclosure may be advantageously employed. For purposes of illustration, FIG. 9 shows three remote units 920, 930, and 950, and two base stations 940. It will be recognized that wireless communication systems may have many more remote units and base stations. Remote units 920, 930, and 950 include IC devices 925A, 925C, and 925B that include the disclosed power fallback wireless local area network receiver. It will be recognized that other devices may also include the disclosed power fallback wireless local area network receiver, such as the base stations, switching devices, and network equipment. FIG. 9 shows forward link signals 980 from the base station 940 to the remote units 920, 930, and 950 and reverse link signals 990 from the remote units 920, 930, and 950 to base station 940.

In FIG. 9, remote unit 920 is shown as a mobile telephone, remote unit 930 is shown as a portable computer, and remote unit 950 is shown as a fixed location remote unit in a wireless communication system. For example, a remote unit may be a mobile phone, a hand-held personal communication systems (PCS) unit, a portable data unit such as a personal digital assistant (PDA), a GPS enabled device, a navigation device, a set top box, a music player, a video player, an entertainment unit, a fixed location data unit such as meter reading equipment, or other communications device that stores or retrieves data or computer instructions, or combinations thereof. Although FIG. 9 illustrates remote units according to the aspects of the disclosure, the disclosure is not limited to these exemplary illustrated units. Aspects of the disclosure may be suitably employed in many devices, which include the disclosed power fallback wireless local area network receiver.

According to a further aspect of the present disclosure, a power saving implementation on a wireless local area network (WLAN) receiver is described. In one configuration, an apparatus such as a user equipment (UE) is configured for wireless communication including means for determining a signal strength of a received frame of a packet during a preamble of the frame. In one aspect, the determining means may be the antenna(s) 225/275/348, transceiver(s) 200/320, transmitter 330, receiver 350, controller(s)/processor(s) 240/310, and/or the memory 260/312 configured to perform the aforementioned means. The UE is also configured to include means for switching the WLAN receiver to a high power mode during the preamble of the frame when the signal strength is above a predetermined signal strength. In one aspect, the switching means may be the controller(s)/processor(s) 240/310, and/or the memory 260/312 configured to perform the aforementioned means. In one configuration, the means functions correspond to the aforementioned structures. In another aspect, the aforementioned means may be any module or any apparatus configured to perform the functions recited by the aforementioned means.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps. What is claimed is:

1. A method of wireless local area network (WLAN) communication, comprising:
determining a signal strength of a received frame of a packet during a short training field of a preamble of the received frame, the determining occurring when a WLAN receiver is operating in a low power mode; and
switching the WLAN receiver to a high power mode during the short training field of the preamble or during a first segment of a long training field of the preamble when the signal strength is above a predetermined signal strength.

2. The method of claim 1, further comprising switching the WLAN receiver from the high power mode to the low power mode based at least in part on a modulating and coding scheme index (MCS), a spatial stream, a WLAN standard, and/or a quality of service.

3. The method of claim 1, further comprising switching the WLAN receiver from the high power mode to the low power mode when it is determined that an end of data for the packet is reached.

4. The method of claim 3, further comprising determining that the end of data for the packet is reached by:
receiving an end of data indication from a modem; or
monitoring the packet and determining the end of data for the packet is reached when data signal of the packet falls below a data threshold value.

5. The method of claim 1, in which switching the WLAN receiver to the high power mode comprises gradually increasing a bias current to an analog to digital converter and a baseband device of the WLAN receiver.

6. The method of claim 1, in which switching the WLAN receiver to the high power mode further comprises switching from a low power synthesizer to a high power synthesizer of the WLAN receiver.

7. The method of claim 1, in which the short training field comprises a legacy short training field (L-STF), a high throughput short training field (HT-STF), a very high throughput short training field (VHT-STF) or a high efficiency short training field (HE-STF).

8. The method of claim 1, in which the long training field comprises a legacy long training field (L-LTF), a high throughput long training field (HT-LTF), a very high throughput long training field (HT-LTF) or a high efficiency long training field (HE-LTF).

9. A WLAN (wireless local area network) communication apparatus, comprising:
a memory; and
at least one processor coupled to the memory, the at least one processor being configured:
to determine a signal strength of a received frame of a packet during a short training field of a preamble of the received frame, the determining occurring when a WLAN receiver is operating in a low power mode; and
to switch the WLAN receiver to a high power mode during the short training field of the preamble or during a first segment of a long training field of the preamble when the signal strength is above a predetermined signal strength.

10. The WLAN communication apparatus of claim 9, in which the at least one processor is further configured to switch the WLAN receiver from the high power mode to the low power mode based at least in part on a modulating and coding scheme index (MCS), a spatial stream, a WLAN standard, and/or a quality of service.

11. The WLAN communication apparatus of claim 9, in which the at least one processor is further configured to switch the WLAN receiver from the high power mode to the low power mode when it is determined that an end of data for the packet is reached.

12. The WLAN communication apparatus of claim 11, in which the at least one processor is further configured to determine that the end of data for the packet is reached by:
receiving an end of data indication from a modem; or
monitoring the packet and determining the end of data for the packet is reached when data signal of the packet falls below a data threshold value.

13. The WLAN communication apparatus of claim 9, in which the at least one processor is further configured to switch the WLAN receiver to the high power mode by gradually increasing a bias current to an analog to digital converter and a baseband device of the WLAN receiver.

14. The WLAN communication apparatus of claim 9, in which the at least one processor is further configured to switch the WLAN receiver to the high power mode by switching from a low power synthesizer to a high power synthesizer of the WLAN receiver.

15. The WLAN communication apparatus of claim 9, in which the short training field comprises a legacy short training field (L-STF), a high throughput short training field (HT-STF), a very high throughput short training field (VHT-STF) or a high efficiency short training field (HE-STF).

16. The WLAN communication apparatus of claim 9, in which the long training field comprises a legacy long training field (L-LTF), a high throughput long training field (HT-LTF), a very high throughput long training field (HT-LTF) or a high efficiency long training field (HE-LTF).

17. A computer program product configured for wireless communication, the computer program product comprising:
a non-transitory computer-readable medium having program code recorded thereon which, when executed by processor(s), causes the processor(s):
to determine a signal strength of a received frame of a packet during a short training field of a preamble of the received frame, the determining occurring when a WLAN receiver is operating in a low power mode; and
to switch the WLAN receiver to a high power mode during the short training field of the preamble or during a first segment of a long training field of the preamble when the signal strength is above a predetermined signal strength.

18. The computer program product of claim 17, in which the program code further causes the processor(s) to switch the WLAN receiver from the high power mode to the low power mode based at least in part on a modulating and coding scheme index (MCS), a spatial stream, a WLAN standard, and/or a quality of service.

19. The computer program product of claim 17, in which the program code further causes the processor(s) to switch the WLAN receiver from the high power mode to the low power mode when it is determined that an end of data for the packet is reached.

20. The computer program product of claim 19, in which the program code further causes the processor(s) to determine the end of data for the packet is reached by:
receiving an end of data indication from a modem; or
monitoring the packet and determining the end of data for the packet is reached when data signal of the packet falls below a data threshold value.

21. The computer program product of claim 17, in which the program code further causes the processor(s) to switch the WLAN receiver to the high power mode by gradually increasing a bias current to an analog to digital converter and a baseband device of the WLAN receiver.

22. The computer program product of claim 17, in which the program code further causes the processor(s) to switch the WLAN receiver to the high power mode by switching from a low power synthesizer to a high power synthesizer of the WLAN receiver.

23. The computer program product of claim 17, in which the short training field comprises a legacy short training field (L-STF), a high throughput short training field (HT-STF), a very high throughput short training field (VHT-STF) or a high efficiency short training field (HE-STF) and in which the long training field comprises a legacy long training field (L-LTF), a high throughput long training field (HT-LTF), a very high throughput long training field (HT-LTF) or a high efficiency long training field (HE-LTF).

24. An apparatus for wireless local area network (WLAN) communication, comprising:
means for determining a signal strength of a received frame of a packet during a short training field of a preamble of the received frame, the determining occurring when a WLAN receiver is operating in a low power mode; and
means for switching the WLAN receiver to a high power mode during the short training field of the preamble or during a first segment of a long training field of the preamble when the signal strength is above a predetermined signal strength.

25. The apparatus of claim 24, further comprising means for switching the WLAN receiver from the high power mode to the low power mode based at least in part on a modulating and coding scheme index (MCS), a spatial stream, a WLAN standard, and/or a quality of service.

26. The apparatus of claim 24, further comprising means for switching the WLAN receiver from the high power mode to the low power mode when it is determined that an end of data for the packet is reached.

27. The apparatus of claim 26, further comprising means for determining the end of data for the packet is reached, in which the end of data determining means further comprises:
means for receiving an end of data indication from a modem; or
means for monitoring the packet and determining the end of data for the packet is reached when data signal of the packet falls below a data threshold value.

28. The apparatus of claim 24, in which the high power mode switching means comprises means for gradually increasing a bias current to an analog to digital converter and a baseband device of the WLAN receiver.

29. The apparatus of claim 24, in which the high power mode switching means comprises means for switching from a low power synthesizer to a high power synthesizer of the WLAN receiver.

30. The apparatus of claim 24, in which the short training field comprises a legacy short training field (L-STF), a high throughput short training field (HT-STF), a very high throughput short training field (VHT-STF) or a high efficiency short training field (HE-STF) and in which the long training field comprises a legacy long training field (L-LTF), a high throughput long training field (HT-LTF), a very high throughput long training field (HT-LTF) or a high efficiency long training field (HE-LTF).
